(19) United States
(12) Patent Application Publication
(10) Pub. No.: US 2014/0041198 A1
(43) Pub. Date: Feb. 13, 2014

(54) METHOD FOR ASSEMBLING LENS MODULE BY USING SUCTION DEVICE

(71) Applicant: CHENG-SHIUN WU, Tu-Cheng (TW)

(72) Inventor: CHENG-SHIUN WU, Tu-Cheng (TW)

(21) Appl. No.: 13/654,611

(22) Filed: Oct. 18, 2012

(30) Foreign Application Priority Data
Aug. 8, 2012 (TW) 101128533

(51) Int. Cl. B23P 11/00

(52) U.S. Cl. 29/466

(57) ABSTRACT

A method for assembling a lens module includes steps described as follows. A first support device and a second support device are provided. Each of the first support device and the second support device includes a base plate and a tray. The tray defines positioning holes. The first support device further includes positioning rods extending from the base plate, bottom magnets defining bottom holes, and upper magnets defining upper holes. The positioning rods extend through the bottom holes, the positioning holes and the upper holes in sequence. The bottom magnets separate the tray from the base plate. The tray of the first support device carries optical elements. The tray of the second support device carries lens barrels. A suction device including suction heads is provided. The suction heads attract the optical elements and put the optical elements into the lens barrels.

### BACKGROUND

1. Technical Field

The present disclosure relates to a method for assembling a lens module.

2. Description of Related Art

Optical elements, such as optical lenses and optical filters, are usually carried by a tray before assembly. The tray is placed on a platform. During assembly, a suction device sucks the optical element from the tray and put the optical element into a barrel. Yet, the surface of the tray is usually uneven and cannot be placed on the platform horizontally, which may prevent the suction device from sucking the optical elements.

Therefore, it is desired to provide a method for assembling a lens module which can overcome the above-mentioned problems.

### BRIEF DESCRIPTION OF THE DRAWINGS

FIGS. 1-5 are schematic views showing successive stages of a method for assembling a lens module according to an exemplary embodiment.

### DETAILED DESCRIPTION

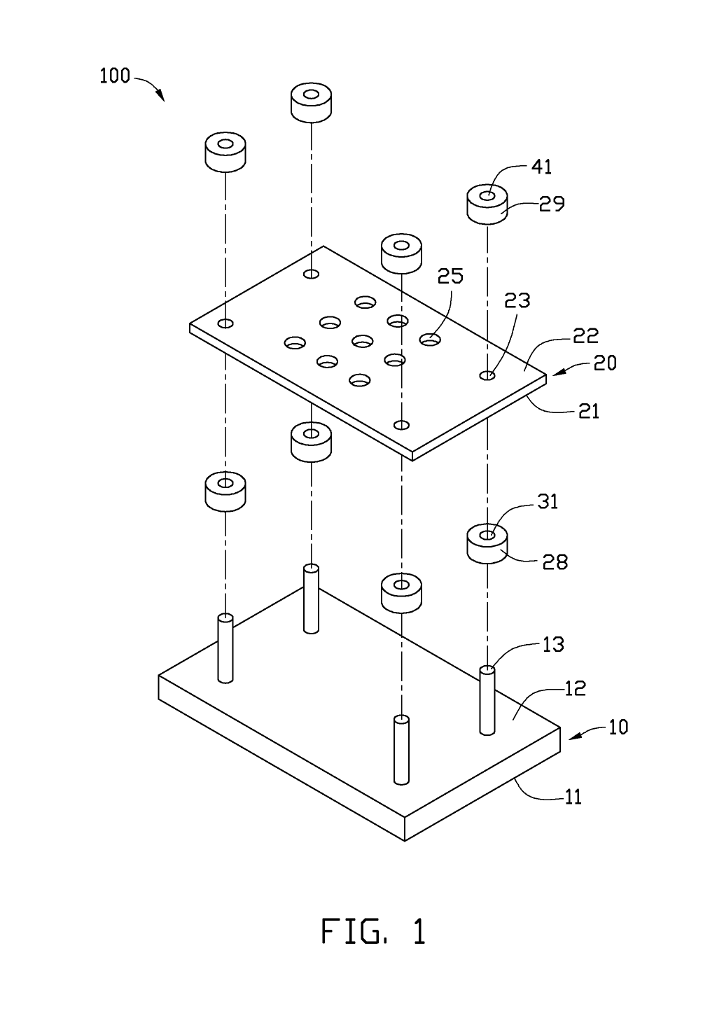

FIGS. 1 to 5 show successive stages of a method for assembling lens modules according to an exemplary embodiment. Each lens module includes an optical element 50, such as a lens or a filter, and a lens barrel 70. The method includes steps described as follows.

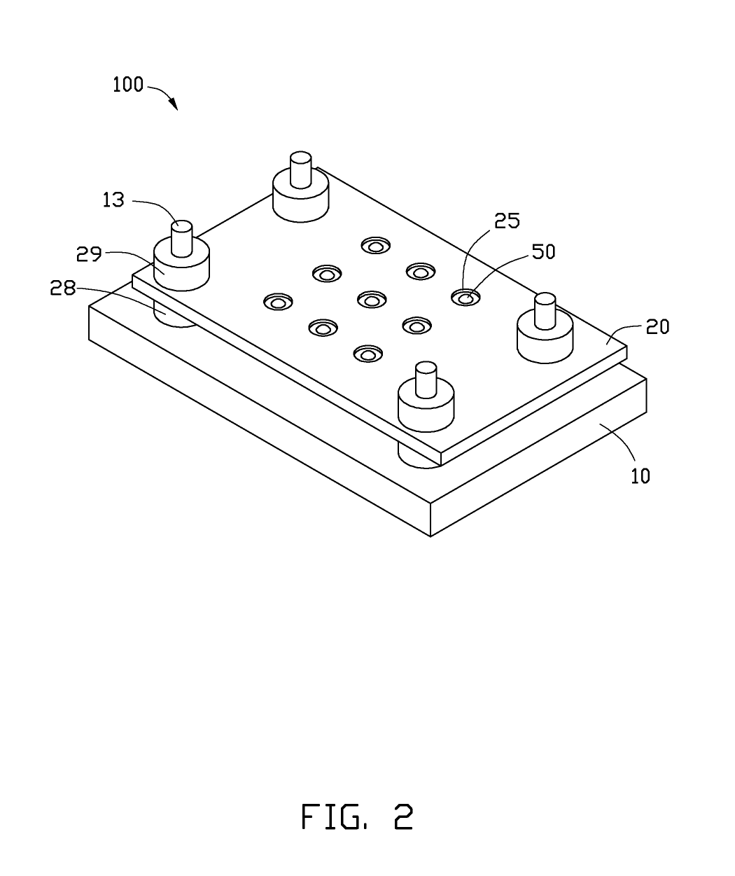

In step 1, as shown in FIGS. 1 and 2, a first support device 100 is provided. The first support device 100 includes a base plate 10, a tray 20, a number of bottom magnets 28, and a number of upper magnets 29.

The base plate 10 is rectangular. The base plate 10 includes a first surface 11 and a second surface 12. The second surface 12 is opposite to the first surface 11. The base plate 10 is put on a platform (not shown). The first surface 11 contacts the platform. A number of positioning rods 13 extend perpendicularly from the second surface 12. In the embodiment, four positioning rods 13 are positioned on four corners of the second surface 12 respectively.

The tray 20 is configured for carrying optical components 50. The tray 20 includes a third surface 21 and a fourth surface 22. The third surface 21 is opposite to the fourth surface 22. The tray 20 defines a number of positioning holes 23 spatially corresponding to the positioning rods 13 respectively. The positioning holes 23 extend from the third surface 21 to the fourth surface 22. The tray 20 further defines a number of receiving holes 25. Each receiving hole 25 receives a respective optical element 50. The third surface 21 and the fourth surface 22 are uneven surfaces because of the existence of the receiving holes 25.

The bottom magnets 28 and the upper magnets 29 are hollow cylinders. Each of the bottom magnets 28 defines a bottom hole 31. Each of the upper magnets 29 defines an upper hole 41.

The positioning rods 13 extend through the bottom holes 31, the positioning holes 23, and the upper holes 41 in sequence. The bottom magnets 28 are sandwiched between the base plate 10 and the tray 20, and contact the second surface 12 and the third surface 21 respectively. The bottom magnets 28 separate the tray 20 from the base plate 10. The upper magnets 29 contact the fourth surface 22. The bottom magnets 28 and the upper magnets 29 attract each other to fix the tray 20.

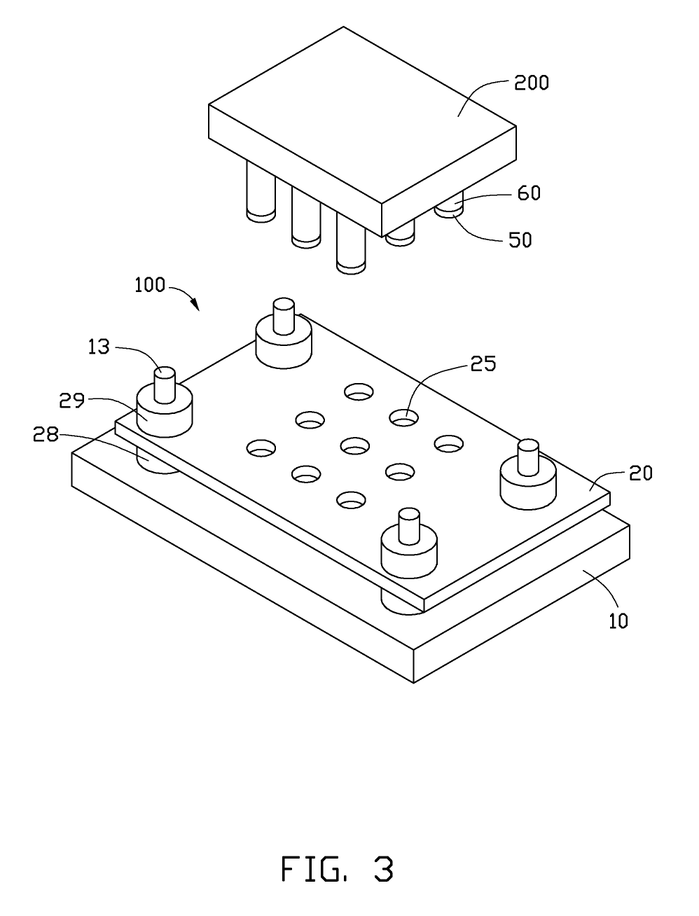

In step 2, as shown in FIG. 3, a suction device 200 is provided. The suction device 200 includes a number of suction heads 60. Each suction head 60 spatially corresponds to one receiving hole 25. The suction device 200 moves down, the suction heads 60 suck the optical elements 50 received in the receiving holes 25, then the suction device 200 moves up.

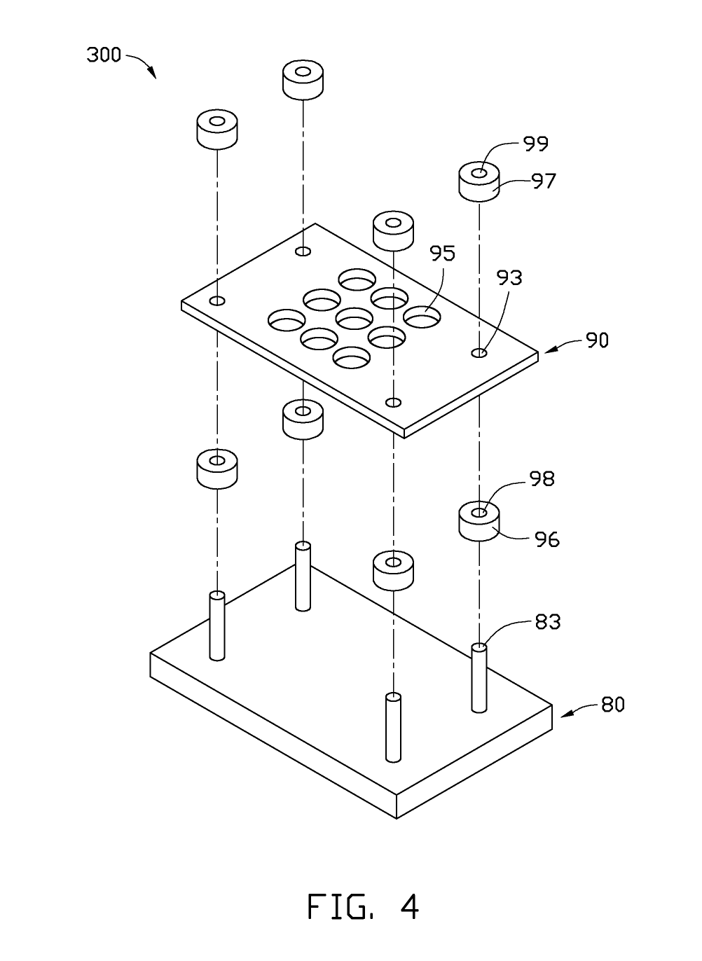

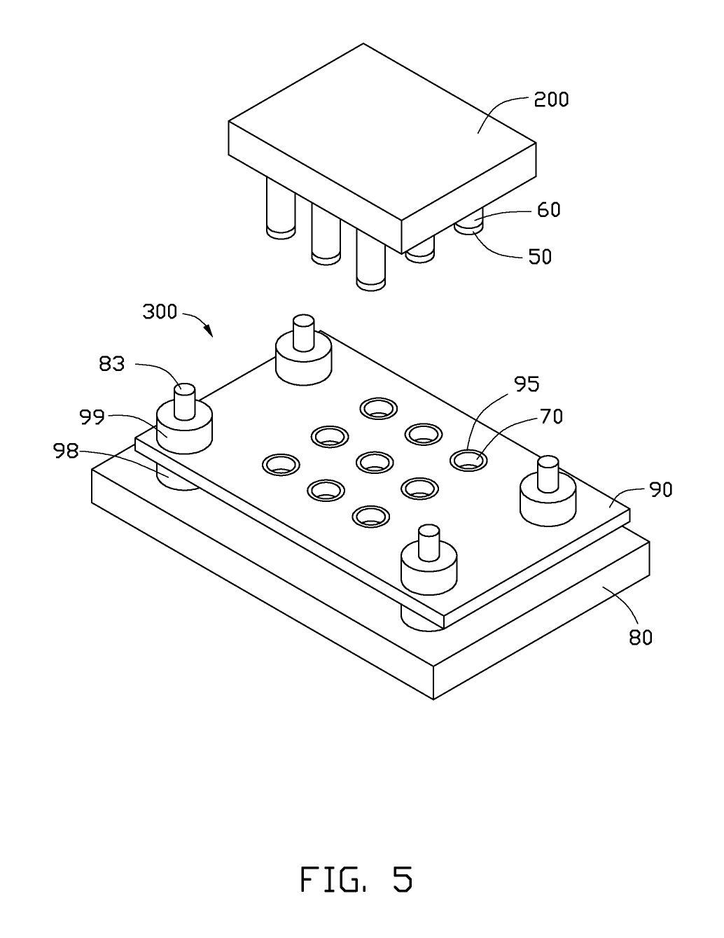

In step 3, as shown in FIGS. 4 and 5, a second support device 300 is provided. The second support device 300 carries a number of lens barrels 70.

The structure of the second support device 300 is similar to that of the first support device 100. The second support device 300 includes a base plate 80, a tray 90, a number of bottom magnets 96, and a number of upper magnets 97.

A number of positioning rods 83 extend perpendicularly from the base plate 80. The tray 90 defines a number of positioning holes 93 spatially corresponding to the positioning rods 83 respectively. The tray 90 further defines a number of receiving holes 95. Each receiving hole 95 receives one lens barrel 70. Each of the bottom magnets 96 defines a bottom hole 98. Each of the upper magnets 97 defines an upper hole 99. The positioning rods 83 extend through the bottom holes 98, the positioning holes 93, and the upper holes 99 in sequence. The bottom magnets 96 are sandwiched between the base plate 80 and the tray 90, and separate the tray 90 from the base plate 80. The bottom magnets 96 and the upper magnets 97 attract each other to fix the tray 90.

In step 4, as shown in FIG. 5, the suction device 200 moves to a position above the second support device 300, each of the optical elements 50 is aligned with a respective one of the lens barrels 70. The suction device 200 moves down and the optical elements 50 attracted by the suction heads 60 are put into the lens barrels 70.

The tray 20 is separated from the base plate 10, and the tray 90 is separated from the base plate 80. Thus, although the trays 20, 90 has uneven surfaces, the trays 20, 90 can be put horizontally, and the suction device 50 can suck the optical elements 50 carried on the tray 20 and put the optical elements 50 into the tray 90 conveniently.

It is to be understood, however, that even though numerous characteristics and advantages of the present embodiments have been set forth in the foregoing description, together with details of the structures and functions of the embodiments, the disclosure is illustrative only, and changes may be made in detail, especially in the matters of shape, size, and arrangement of parts within the principles of the disclosure to the full extent indicated by the broad general meaning of the terms in which the appended claims are expressed.

What is claimed is:

1. A method for assembling a lens module, the method comprising:
providing a first support device and a second support device, each of the first support device and the second support device comprising a base plate, a plurality of positioning rods extending from the base plate, a plurality of bottom magnets, a tray defining a plurality of positioning holes, and a plurality of upper magnets, each of the bottom magnets defining a bottom hole, each of the upper magnets defining an upper hole, each of the positioning rods extending through a respective one of the bottom holes, a respective one of the positioning holes, and a respective one of the upper holes in sequence, the bottom magnets separating the tray from the base plate, the tray of the first supporting device carrying a plurality of optical elements, the tray of the second supporting device carrying a plurality of lens barrels;
providing a suction device, the suction device comprising a plurality of suction heads;
attaching the optical elements on the suction heads;
moving the suction heads over the tray of the second supporting device, with each of the optical elements aligned with a respective one of the lens barrels; and
separating the optical elements from the suction heads to put the optical elements into the lens barrels.

2. The method of claim 1, wherein the base plate comprises a first surface and a second surface opposite to the first surface, the second surface faces the tray, and the positioning rods extend from the second surface.

3. The method of claim 2, wherein the positioning rods perpendicularly extend from the second surface.

4. The method of claim 1, wherein the bottom magnets and the upper magnets are hollow cylinders.

5. The method of claim 1, wherein the tray comprises a third surface and a fourth surface opposite to the third surface, the third surface faces the base plate, and the bottom magnets touch the third surface and the base plate, and the upper magnets are positioned on the fourth surface.
